(19) United States
(12) Patent Application Publication
(10) Pub. No.: US 2024/0247488 A1
(43) Pub. Date: Jul. 25, 2024

(54) 3D-PRINTED BUILDING MATERIAL SYSTEM

(71) Applicant: RENNSSELAER POLYTECHNIC INSTITUTE, Troy, NY (US)

(72) Inventors: Nadarajah Narendran, Clifton Park, NY (US); Ukwatte Lokuliyanage Indika Perera, Clifton Park, NY (US); Jean Paul Freyssinier, Troy, NY (US)

(73) Assignee: RENSSELAER POLYTECHNIC INSTITUTE, Troy, NY (US)

(21) Appl. No.: 18/564,169

(22) PCT Filed: May 27, 2022
(86) PCT No.: PCT/US22/31249

§ 371 Date: Nov. 27, 2023

Related U.S. Application Data
(60) Provisional application No. 63/193,645, filed on May 27, 2021.

(51) Int. Cl. E04C 2/52; B33Y 80/00

(52) U.S. Cl. CPC E04C 2/526; B33Y 80/00

(57) ABSTRACT

One embodiment provides a building material element. The building material element includes a three-dimensional (3D)-printed architectural element, and an integrated functional feature related to a functional element.

### CROSS REFERENCE TO RELATED APPLICATION(S)

This application claims the benefit of U.S. Provisional Application No. 63/193,645, filed May 27, 2021, which is incorporated by reference as if disclosed herein in its entirety.

### FIELD

The present disclosure relates to a building material system, in particular to, a three-dimensional (3D)-printed building material system.

### BACKGROUND

Digital technologies continue to impact all aspects of modern life, from electronics to computing software, communication and manufacturing. In the construction industry, building information modeling (BIM) tools enable using digital technologies to improve workflow, increase safety, energy efficiency and comfort, and to address real time design changes and supply chain disruptions. One such technology is additive manufacturing (AM), commonly known as 3D (three-dimensional) printing. Broadly, 3D printing may boost economic productivity while addressing concerns due to growing world population, rapid urbanization, and climate change. It has been estimated that 3D printing can save 25% of the energy used in manufacturing compared to traditional fabrication methods. More specifically, there is an increasing interest in the use of 3D printing in the Architecture, Engineering, and Construction (AEC) industry at least in part due to its potential to revolutionize existing building practices and materials.

### SUMMARY

In some embodiments, there is provided a building material element. The building material element includes a three-dimensional (3D)-printed architectural element and an integrated functional feature related to a functional element.

In some embodiments of the building material element, the 3D-printed architectural element is selected from the group including at least a portion of a wall panel, at least a portion of a ceiling panel, at least a portion of a floor panel, at least a portion of a crown molding, at least a portion of a chair railing, and at least a portion of a floor molding.

In some embodiments of the building material element, the 3D-printed architectural element includes a decorative feature.

In some embodiments of the building material element, the integrated functional feature is configured to accommodate the functional element.

In some embodiments of the building material element, the integrated functional feature corresponds to the functional element In some embodiments of the building material element, the functional element includes one or more of a lighting apparatus, an electrical connectivity apparatus, an electronic device, a computing device, a communication device, a sensor hub, and/or a sensor.

In some embodiments of the building material element, the functional element includes a 3D-printed insulation material.

In some embodiments of the building material element, the sensor is configured to sense one or more of an environmental parameter, an electrical parameter, an electromagnetic parameter, a mechanical parameter, and/or an acoustic parameter.

In some embodiments of the building material element, an infill characteristic of the 3D-printed insulation material is selected based, at least in part, on a target physical characteristic, the target physical characteristic selected from the group including a target thermal characteristic, a target mechanical characteristic, a target weight of the building material element, and/or a target permeability. The infill characteristic is selected from the group including an infill pattern, an infill percentage, and a selected infill material.

In some embodiments, there is provided a building material system. The building material system includes a plurality of interconnected building material elements, and a light source associated with a selected building material element. Each building material element includes a three-dimensional (3D)-printed architectural element, and an integrated functional feature related to a functional element.

In some embodiments of the building material system, each 3D-printed architectural element is the same as each other 3D-printed architectural element.

In some embodiments of the building material system, at least one 3D-printed architectural element is a different type from at least one other 3D-printed architectural element.

In some embodiments of the building material system, each 3D-printed architectural element is selected from the group including at least a portion of a wall panel, at least a portion of a ceiling panel, at least a portion of a floor panel, at least a portion of a crown molding, at least a portion of a chair railing, and at least a portion of a floor molding.

In some embodiments of the building material system, at least one 3D-printed architectural element includes a decorative feature.

In some embodiments of the building material system, at least one integrated functional feature is configured to accommodate the functional element.

In some embodiments of the building material system, at least one integrated functional feature corresponds to the functional element

In some embodiments of the building material system, the functional element includes one or more of a lighting apparatus, an electrical connectivity apparatus, an electronic device, a computing device, a communication device, a sensor hub, and/or a sensor.

In some embodiments of the building material system, the functional element includes a 3D-printed insulation material.

In some embodiments of the building material system, the sensor is configured to sense one or more of an environmental parameter, an electrical parameter, an electromagnetic parameter, a mechanical parameter, and/or an acoustic parameter.

In some embodiments of the building material system, an infill characteristic of the 3D-printed insulation material is selected based, at least in part, on a target physical characteristic. The target physical characteristic is selected from the group including a target thermal characteristic, a target mechanical characteristic, a target weight of the building material element, and/or a target permeability. The infill characteristic is selected from the group including an infill pattern, an infill percentage, and a selected infill material.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 is a sketch illustrating a front view of a portion of an example building material system, according to several embodiments of the present disclosure;

FIGS. 2A and 2B are sketches of isometric views of example building material elements illustrating example interconnect features, according to several embodiments of the present disclosure;

FIG. 3 is a sketch illustrating an isometric view of another example building material element, illustrating cove lighting;

FIG. 4 is a sketch illustrating an isometric view of an example building material structure, illustrating step lighting, wall and floor portions, and integrated sensing;

FIG. 5 is a sketch illustrating an isometric view of another example building material element, illustrating another example of cove lighting;

FIG. 6 is a sketch illustrating an isometric view of another example building material structure, illustrating cove lighting for wall washing illumination, and integrated sensing;

FIG. 7 is a sketch illustrating an isometric view of an example building material structure, illustrating ceiling lighting, and a ceiling portion;

FIG. 8 is a sketch illustrating an isometric view of another example building material structure, illustrating cove lighting for wall washing illumination, and a ceiling portion;

FIG. 9 is a sketch illustrating an isometric view of an example building material portion, illustrating one example of a plurality of interconnected 3D-printed architectural elements;

FIG. 10 is a sketch illustrating a front view of an example building material element, according to an embodiment of the present disclosure;

FIG. 11 is a sketch illustrating a front view of an example building material element, including a duplex electrical outlet, according to one embodiment of the present disclosure;

FIG. 12 is a sketch illustrating a back view of an example building material element, illustrating example structural features, according to an embodiment of the present disclosure;

FIG. 13 is a sketch of an isometric view of a back side of an example building material element, illustrating functional features configured to accommodate functional element(s), according to an embodiment of the present disclosure;

FIG. 14A is a sketch of a front view of an example building material element, according to several embodiments of the present disclosure;

FIGS. 14B and 14C illustrate cross-sections A-A′ of two embodiments of the example building material element of FIG. 14A, configured to illustrate infill, according to several embodiments of the present disclosure; and

FIGS. 15A through 15C are sketches of internal structures of example building material elements configured to illustrate a plurality of example infill characteristics of the building material element of FIG. 14A.

### DESCRIPTION

Generally, there is disclosed herein a building material system that includes at least one building material element. In some embodiments, the building material element may be modular such that a plurality of building material elements may be interconnected to form a corresponding building material system. The building material element includes a three-dimensional (3D)-printed architectural element and may include an integrated functional feature related to a functional element. The 3D-printed architectural element (i.e., type of 3D-printed architectural element) may include, but is not limited to, at least a portion of a wall panel, at least a portion of a ceiling panel, at least a portion of a floor panel, at least a portion of a wallboard, at least a portion of a crown molding, at least a portion of a chair railing, and at least a portion of a floor molding, etc. A building material structure includes at least a portion of at least two 3D-printed architectural elements. In some embodiments, the 3D-printed architectural elements are a same type. In some embodiments, at least one 3D-printed architectural element is a different type from at least one other 3D-printed architectural element. A building material system, according to the present disclosure, may include, but is not limited to, a ceiling panel, a floor panel, a wallboard (i.e., wall panel), a crown molding, a chair railing, a floor molding (i.e., floor trim), a trim board, and/or a combination thereof.

In some embodiments, a 3D-printed architectural element may include a selected surface texture property. Each property may be related to a selected building interior characteristic. In some embodiments, a 3D-printed architectural element may include a decorative feature. In one nonlimiting example, the decorative feature may include a 3D texture on a front surface of each of one or more 3D-printed architectural element(s). However, this disclosure is not limited in this regard. The texture may thus correspond to one or more decorative feature(s).

In an embodiment, the integrated functional feature may correspond to a functional element. In some embodiments, the functional element may include a 3D-printed insulation material. In some embodiments, the integrated functional feature may be configured to provide one or more of a selected mechanical property (i.e., characteristic), a selected thermal property (e.g., thermal conductance, and/or liquid and/or gas permeability), and/or a selected acoustic property.

In an embodiment, the integrated functional feature may be configured to accommodate a functional element. A functional element may include, but is not limited to, a lighting apparatus, an electrical connectivity apparatus, an electronic device (e.g., analog circuitry, digital circuitry, a battery charger, etc.), a computing device, a communication device (e.g., an antenna, a transmitter, a receiver, etc.), a sensor hub (e.g., circuitry (e.g., a microcontroller, a coprocessor, or a digital signal processor) configured to integrate and/or process sensor data), and/or a sensor.

In some embodiments, the lighting apparatus may include, but is not limited to, light source, luminaire, light emitting diode (LED), array of LEDs, strip of LEDs, light bulb, etc. In some embodiments, the electrical connectivity apparatus may include, but is not limited to, wiring, a conduit channel, an electrical outlet, a lighting controller, etc. In some embodiments, the computing device may include, but is not limited to, a processor, a microcontroller, an application specific integrated circuit (ASIC), a system on a chip, a field programmable gate array (FPGA), etc.

In some embodiments, the sensor(s) may be configured to sense one or more of an environmental parameter, an electrical parameter (e.g., voltage, current, power consumption, frequency), an electromagnetic parameter, a mechanical parameter (e.g., weight, force), an acoustic parameter, etc. Environmental parameters may include, but are not limited to, light (e.g., intensity, spectrum), temperature, relative humidity, water, smoke, carbon monoxide (CO) and carbon dioxide (CO₂), air quality, selected pollutants, and/or biohazards, etc.

It is contemplated that some functional elements, according to the present disclosure, may include, electronic and/or electromechanical subassemblies associated with smart buildings. In one nonlimiting example, the subassemblies may correspond to the Internet of Things (IOT).

It may be appreciated that a building material element and/or building material system, according to the present disclosure, may include more than one functional element. Flexibility associated with 3D printing may facilitate producing a building material system of nearly any size, with a customized surface texture, and that includes one or more selected integrated functional features (e.g., integrated lighting). A building material element and system, according to the present disclosure, may facilitate implementation of smart buildings, e.g., “smart homes”.

Advantageously, a building material system that includes at least one building material element, according to the present disclosure, may facilitate custom designs without corresponding tooling costs, with relatively shorter design times and/or relatively shorter production lead times. Additionally or alternatively, the building material system may facilitate implementing relatively low cost custom lighting configurations, integrated with the 3D-printed architectural element. Additionally or alternatively, the building material system may support a relatively simplified installation process, including, for example, fewer steps for installing specialty modules with built-in lighting. Such a simplified installation process may result in a reduced time for installing the building material system, fewer rejects and/or fewer call-backs.

Additionally or alternatively, the building material system, according to the present disclosure, may provide improved consistency from element to element. Additionally or alternatively, the building material system may facilitate printing building material elements to fit actual conditions, on-site, including, for example, unusual and/or nonstandard dimensions. Additionally or alternatively, the building material system may be designed integral with a target architectural space (e.g., residential home, historic building renovation, commercial office space, retail space, etc.) thus providing matching design features between the architectural space and the building material system. Additionally or alternatively, the building material system may facilitate 3D-printing of at least the architectural element at or near a building site and may thus result in reduced transportation costs, reduced manufacturing and/or transportation time, and/or reduced carbon footprint.

In some embodiments, building material elements, according to the present disclosure, may be configured to incorporate one or more of lighting, pre-routed channels to simplify house wiring (outlets, lighting, etc.), electrical connections (e.g., wall outlets, low or mains voltage, alternating or direct current), and/or sensor(s), as described herein.

In some embodiments, a building material element, according to the present disclosure, may include a 3D-printed architectural element (e.g., wall board portion) and an insulating material (i.e., integrated functional element). A target physical characteristic, for example, a thermal characteristic of the building material element may be adjusted by adjusting characteristics associated with the insulating material. In one nonlimiting example, insulating and/or permeability properties of the insulating material may be modulated by one or more of varying the infill-percentage, and/or incorporating cavities of varying dimensions and geometric designs to control thermal resistance. For example, the cavities may be voids (i.e., may contain air). In another example, the cavities may contain one or more materials selected to control an R-value of the wall board. In some embodiments, the 3D-printed architectural element may define one or more capillary channel(s) (i.e., integrated functional feature) to provide permeability configured to facilitate material breathing and/or control of relative humidity.

In some embodiments, the building material element may include a plurality of materials. In these embodiments, an integrated functional element may include a secondary material. In one nonlimiting example, the secondary material may include a phase-change material configured to manage thermal comfort in an interior space with latent heat. As is known, phase-change materials may release or absorb energy at a phase transition to provide heating or cooling. Phase change materials may include, but are not limited to, organic materials (e.g., carbon-containing materials derived from petroleum, plants and/or animals) or inorganic materials (e.g., salt hydrates using natural salts from a sea or mineral deposits, and/or as byproducts of other processes).

Thus, thermal conductivity of the building material elements may be managed via one or more of selection of materials with appropriate material(s) properties, selection of appropriate geometric design of building material element and/or design of internal structure and/or external surface finish (e.g., smooth vs. textured).

A target physical characteristic of a building material element that includes infill may be affected by an infill characteristic. In one nonlimiting example, the infill characteristic may be configured to provide the target physical characteristic for the building material element, and associated building material system. Infill characteristics may include, but are not limited to, an infill percentage, an infill pattern, and/or a selected infill material. Each infill material may be selected from a 3D printing material, as described herein, and may be selected based, at least in part, on a material characteristic. An infill characteristic may be selected based, at least in part, on a target physical characteristic of the corresponding building material element. Target physical characteristics include, but are not limited to, a thermal characteristic, a mechanical characteristic, a weight, etc. In one nonlimiting example, a thermal characteristic may correspond to a thermal conductivity. In another example, a target physical characteristic may correspond to a liquid (or gas) permeability of the building material element.

3D-printed building material systems, including at least one 3D-printed architectural element and an integrated functional feature related to a functional element, according to the present disclosure, are configured to be 3D-printed using an appropriate 3D printing process and an appropriate material or materials. It may be appreciated that manufacturing details associated with 3D printing are 3D printer-specific and may vary according to 3D printer technology, characteristics (e.g., shape, size, etc.) of the structure(s) to be printed and/or materials used in the 3D printing process. Materials may include, for example, one or more of a synthetic polymer (e.g., a thermoplastic) or organic polymer, a metal (e.g., copper, zinc, brass, aluminum, etc.), carbon, carbon fiber, sandstone, wood fiber, etc. Polymers may include, but are not limited to, nylon, polyethylene, polyester, acrylonitrile butadiene styrene (ABS)), polyethylene terephthalate (PET), thermoplastic elastomer, poly lactic acid (PLA), polyvinyl alcohol, polystyrene, etc. An appropriate material or materials may be application-specific.

Thus, a building material element, according to the present disclosure includes a three-dimensional (3D)-printed architectural element and an integrated functional feature related to a functional element. The 3D-printed architectural element may include a decorative feature. In some embodiments, the integrated functional feature may be configured to accommodate the functional element. In some embodiments, the integrated functional feature may correspond to the functional element. Integrated functional features that are configured to accommodate functional element(s) may include, but are not limited to, a channel (e.g., cove, in cove lighting), a light transfer structure (e.g., a reflector), an opening, a void, a cavity, etc. Integrated functional features that correspond to functional elements may include, but are not limited to, a lighting element (e.g., light source, luminaire, light emitting diode (LED), array of LEDs, strip of LEDs, light bulb, etc.), wiring (e.g., electrical, loudspeaker, communication, etc.), insulating material (including geometric structure of the insulating material, infill percentage), etc.

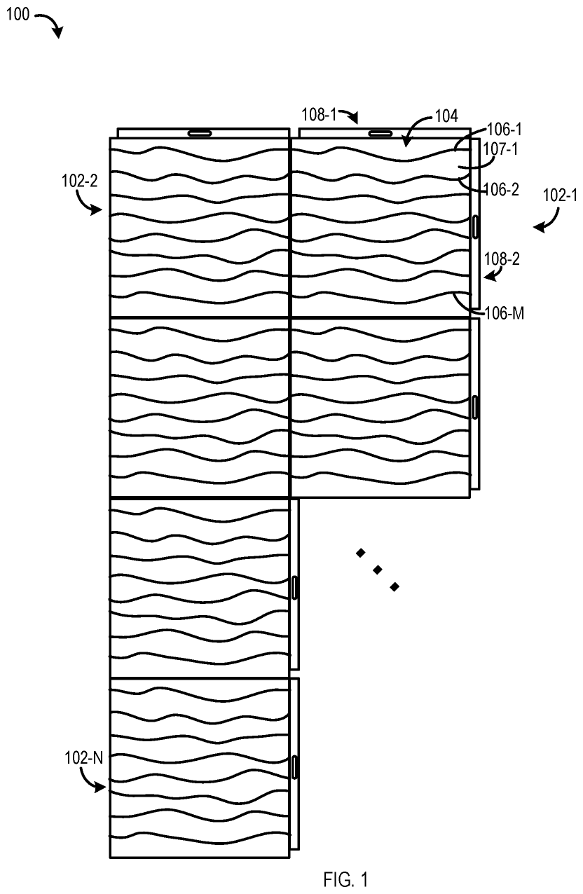

FIG. 1 is a sketch 100 illustrating a front view of a portion of an example building material system, according to several embodiments of the present disclosure. The example building material system may include a wall board (i.e., wall panel), a floor panel, a ceiling panel, and/or a combination thereof. Example portion 100 includes a plurality of interconnected building material elements 102-1, 102-2, . . . , 102-N. In this example portion 100, the building material elements 102-1, 102-2, . . . , 102-N are modular. As used herein, “front” corresponds to a surface that may be visible when the building material system is in position in a building structure, e.g., the surface of a wall. As used herein, “back” corresponds to a surface that may not be visible when the building material system is in position in the building structure, e.g., an inner surface, generally opposing the front surface. For example, the front surface may include one or more decorative feature(s). However, this disclosure is not limited in this regard. In another example, the back surface may include or may be configured to accommodate a functional element. However, this disclosure is not limited in this regard.

Each building material element, e.g., building material element 102-1, includes a front surface 104 that may include decorative features. The decorative features may include, for example, a surface texture. In some embodiments, the surface texture may be functional, e.g., non-skid texture for a floor panel. The surface texture may include one or more peaks 106-1, 106-2, . . . , 106-M and one or more valleys positioned between adjacent peaks, e.g., valley 107-1 positioned between a first peak 106-1 and an adjacent second peak 106-2. The front surface 104 may thus correspond to a 3D surface texture. In this example 100, the decorative features are generally freeform as indicated by the wavy lines 106-1, 106-2, . . . , 106-M. However, this disclosure is not limited in this regard. The decorative features may be three-dimensional, and/or may include, but are not limited to, geometric shapes, depictions of flora and/or fauna, and/or may be freeform. It may be appreciated that 3D printing may provide a relatively wide range of options for the surface texture and decorative features. Each building material element, e.g., building material element 102-1, includes at least one interconnection feature, e.g., interconnection features 108-1, 108-2. The interconnection features 108-1, 108-2 are configured to couple the building material element 102-1 to an adjacent building material element. In this example 100, the interconnection features 108-1, 108-2 are configured to be behind corresponding meeting interconnection features of the adjacent building material element. For example, building material element 102-2 has an interconnection feature positioned behind an adjacent portion of building material element 102-1 that is thus not visible. In one embodiment, the front surface 104 of the example building material system portion 100 may appear to be continuous. In another embodiment, the front surface 104 of the material system portion 100 may include further decorative features between a selected building material element, e.g., building material element 102-1, and at least one adjacent building material element, e.g., building material element 102-2. In one nonlimiting example, the decorative features may be included in or on the interconnection features. However, this disclosure is not limited in this regard.

Thus, a plurality of building material elements may be interconnected to form a building material system.

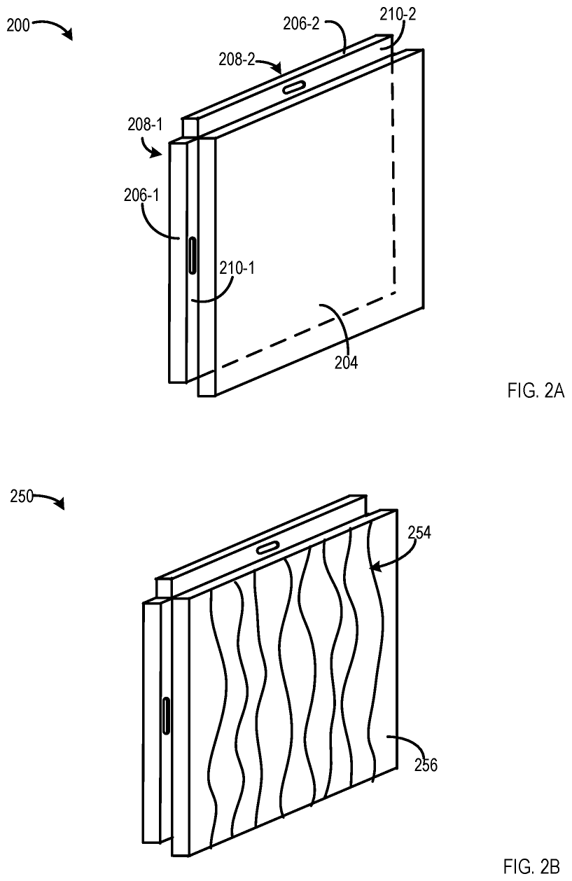

FIGS. 2A and 2B are sketches 200, 250 of isometric views of example building material elements illustrating example interconnect features, according to several embodiments of the present disclosure. FIGS. 2A and 2B may be best understood when considered together. Example building material element 200 is shown without decorative front surface detail to facilitate illustrating the interconnect detail and the structure of the building material element that may hide the interconnect detail when a plurality of building material elements are interconnected, as described herein. Example building material element 250 corresponds to building material element 200 with decorative surface detail 254 on a front surface 256.

Example building material element 200 includes a front surface 204 and two interconnection features 206-1, 206-2. A first interconnection feature 206-1 is positioned along a left edge 208-1 of the building material element 200. A second interconnection feature 206-2 is positioned along a top edge 208-2 of the building material element 200. As used herein, “top”, “bottom”, “left”, and “right” are terms of convenience configured to indicate a relative position, and not necessarily orientation in space, when the building material element(s) are in their as-built positions. A respective front surface 210-1, 210-2 of each interconnection feature 206-1, 206-2 is not aligned with the front surface 204. In other words, the front surfaces 210-1, 210-2 are positioned behind a plane that includes the front surface 204 of the building material element 200. The “indenting” of the front surfaces of the interconnection features facilitates hiding the interconnection of building material element 200 and adjacent building material elements.

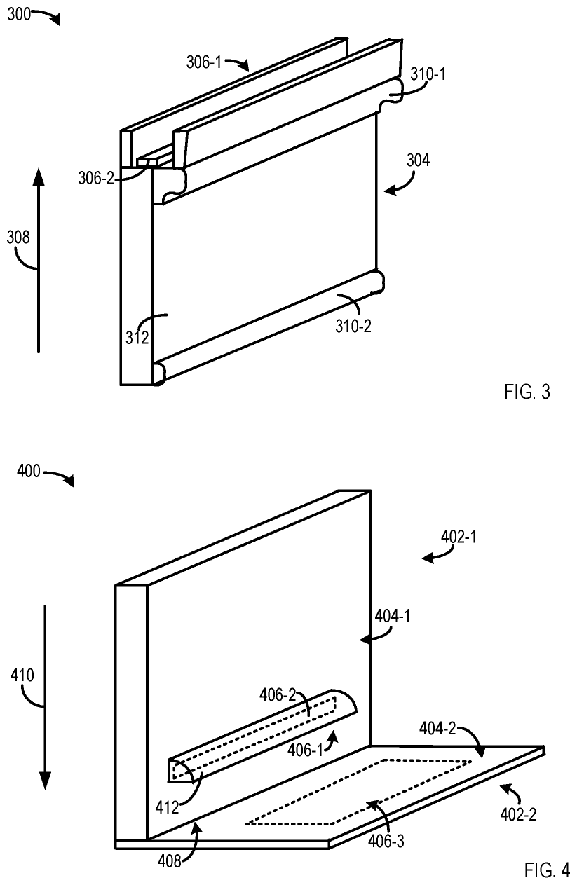

FIG. 3 is a sketch 300 illustrating an isometric view of another example building material element, illustrating cove lighting. Example building material element 300 includes a 3D-printed architectural element 304, and a plurality of integrated functional features 306-1, 306-2. In one nonlimiting example, example building material element 300 may correspond to a portion of a trim board configured to be positioned near a top of a wall panel. However, this disclosure is not limited in this regard.

Example building material element 300 defines a first functional feature 306-1 corresponding to a channel, e.g., a cove, positioned at or near a top surface of the architectural element 304. The first functional feature 306-1 is configured to receive a second functional feature 306-2. The second functional feature 306-2 may include a lighting element, e.g., a strip of LEDs, configured to provide illumination in an upward direction 308. A combination of the first functional feature 306-1 (i.e., cove) and the second functional feature (i.e., functional element 306-2) may be configured to manage a lighting characteristic (i.e., lighting property). Lighting characteristics may include, but are not limited to, intensity, spectrum (i.e., spectral content), and/or distribution. Thus, the first functional feature 306-1 is configured to accommodate the second functional feature, i.e., functional element 306-2.

Cove lighting, in this example, corresponds to a type of uplighting that may be configured to direct light to a ceiling. A cove may correspond to a channel, defined by an associated building material element. The cove may correspond to an integrated functional feature configured to accommodate a functional element, e.g., a lighting source. The cove may be configured to manage a distribution of transmitted light from the light source. A cross-section of the cove may be rectangular, semicircular, a portion of an ellipse, freeform, etc. A surface of the cove may be reflective and/or may have reflective properties. The cove may thus be included in a building material element, included in a building material system. The building material system may correspond to a wallboard, for example. The building material system, including the cove lighting, may then be positioned on one or more sides of a room, configured to provide overall diffuse illumination.

Cove lighting may be mounted to or incorporated into a wall, and/or located within a ceiling coffer. As is known, cove lighting may be configured for wall washing. Wall washing may be configured to illuminate a vertical surface with generally uniform brightness. Wall washing may be configured to draw attention to the wall, and can be used to accentuate an entrance, fireplace, or artwork. In one nonlimiting example, light reflected from a matte surface wall may cause a room to appear relatively bright and may provide a soft, diffuse light in the room. In one nonlimiting example, decorative features, e.g., surface texture, of a wall portion may be enhanced by such wall-washing.

The 3D-printed architectural element 304 includes a plurality of decorative features 310-1, 310-2 positioned on a front surface 312 of the 3D-printed architectural element 304. In this example 300, a first decorative feature 310-1 is positioned adjacent the cove 306-1 and a second decorative feature 310-2 is positioned opposite the cove 306-1, at or near a bottom of the architectural element 304. In this example 300, the decorative features 310-1, 310-2 have a generally curved surfaces. However, this disclosure is not limited in this regard and other surface shapes may be implemented, consistent with the present disclosure.

FIG. 4 is a sketch 400 illustrating an isometric view of an example building material structure, illustrating step lighting, wall and floor portions, and integrated sensing. As used herein, a building material structure includes at least a portion of at least two 3D-printed architectural elements. In some embodiments, the 3D-printed architectural elements are a same type. In some embodiments, at least one 3D-printed architectural element is a different type from at least one other 3D-printed architectural element.

Example building material structure 400 includes a wall portion 402-1, and a floor panel portion 402-2. The wall portion 402-1 includes a 3D-printed architectural element 404-1, and a plurality of integrated functional features 406-1, 406-2. In one nonlimiting example, wall portion 402-1 may correspond to a portion of a trim board configured to be positioned near a bottom of a wall panel. However, this disclosure is not limited in this regard. The floor panel portion 402-2 includes a 3D-printed architectural element 404-2, and a third integrated functional feature 406-3.

A first integrated functional feature 406-1 corresponds to light transfer structure, e.g., a reflector, positioned near a bottom 408 of the architectural element 404-1. A second functional feature 406-2 may include a lighting element, e.g., a strip of LEDs, configured to provide illumination from a front surface of the architectural element 404-1. The first functional feature 406-1 is configured to constrain illumination in a downward direction 410. The first functional feature 406-1 may define a cavity 412 configured to receive the lighting element 406-2. The first functional feature 406-1 may include an internal reflective surface to facilitate directing the light from the light engine 406-2 downward. Thus, the first functional feature 406-1 is configured to accommodate the second functional feature, i.e., functional element 406-2.

The third integrated functional feature 406-3 may be configured to accommodate (i.e., receive) a sensor, e.g., a weight sensor (i.e., a scale), to measure a weight. Thus, the third integrated functional feature 406-3 may be configured to accommodate a functional element. However, this disclosure is not limited in this regard.

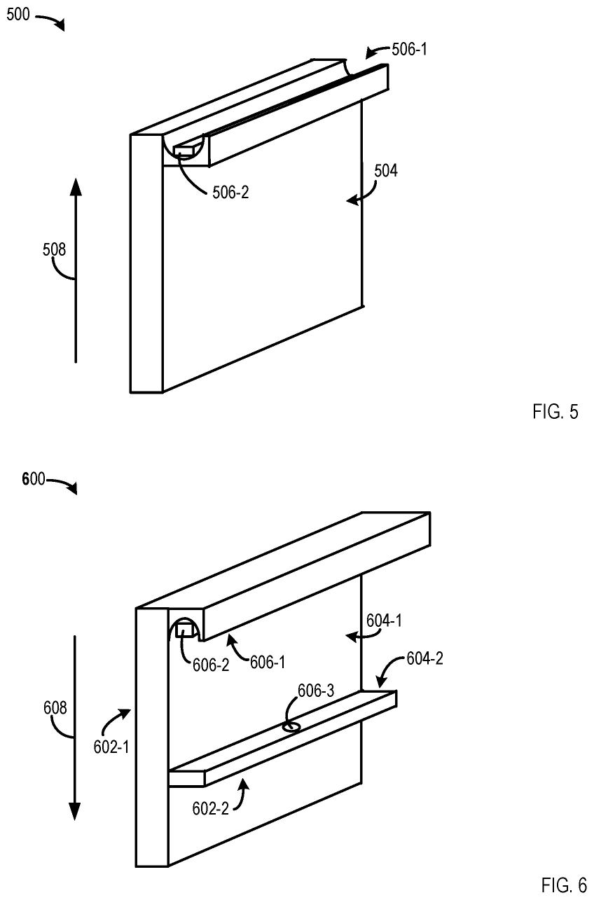

FIG. 5 is a sketch 500 illustrating an isometric view of another example building material element, illustrating another example of cove lighting. Example building material element 500 includes a 3D-printed architectural element 504, and a plurality of integrated functional features 506-1, 506-2. The building material element 500 defines a first functional feature 506-1 corresponding to a channel, e.g., a cove, positioned at or near a top surface of the architectural element 504. The first functional feature 506-1 is configured to contain a second functional feature 506-2. The second functional feature 506-2 may include a lighting element, e.g., a strip of LEDs, configured to provide illumination in an upward direction 508, i.e., uplighting. Thus, the first functional feature 506-1 is configured to accommodate the second functional feature, i.e., functional element 506-2.

FIG. 6 is a sketch 600 illustrating an isometric view of another example building material structure, illustrating cove lighting for wall washing illumination, and integrated sensing. Example building material structure 600 includes a wall portion 602-1, and a shelf portion 602-2. The wall portion 602-1 includes a 3D-printed architectural element 604-1, and a plurality of integrated functional features 606-1, 606-2. The shelf portion 602-2 is positioned below the plurality of integrated functional features 606-1, 606-2 on a front surface of the 3D-printed architectural element 604-1. The wall portion 602-1 defines a first functional feature 606-1 corresponding to a channel, e.g., a cove, positioned at or near a top surface of the architectural element 604-1. The first functional feature 606-1 is configured to receive a second functional feature 606-2. The second functional feature 606-2 may include a lighting element, e.g., a strip of LEDs, configured to provide illumination in an downward direction 608, i.e., downlighting. In one nonlimiting example, the lighting element may thus be configured to illuminate the shelf portion 602-2. However, this disclosure is not limited in this regard. Thus, the first functional feature 606-1 is configured to accommodate the second functional feature, i.e., functional element 606-2.

The shelf portion 602-2 includes a 3D-printed architectural element 604-2, and a third integrated functional feature 606-3. In one nonlimiting example, the third integrated functional feature 606-3 may correspond to a battery charger (e.g., a wireless battery charger) configured to charge a user electronic device (e.g., a cellular telephone, tablet computer, or laptop computer) wirelessly. However, this disclosure is not limited in this regard.

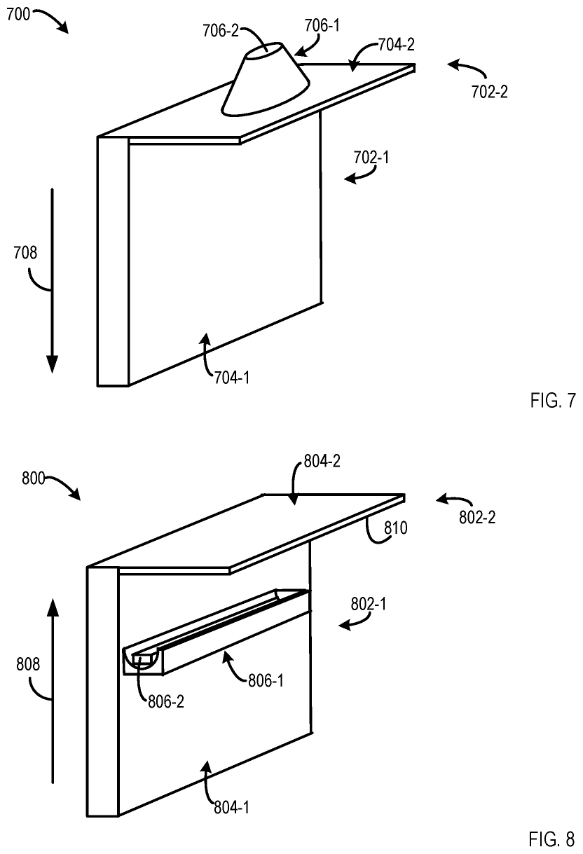

FIG. 7 is a sketch 700 illustrating an isometric view of an example building material structure, illustrating ceiling lighting, and a ceiling portion. Example building material structure 700 includes a wall portion 702-1, and a ceiling portion 702-2. The wall portion 702-1 includes a 3D-printed architectural element 704-1. The ceiling portion 702-2 includes a 3D-printed architectural element 704-2, and a plurality of integrated functional features 706-1, 706-2. The wall portion 702-1 may be coupled to the ceiling portion 702-2. A first functional feature 706-1 corresponds to a reflector, positioned at or near a top surface of the ceiling portion 702-2. The first functional feature 706-1 is configured to receive a second functional feature 706-2. The second functional feature 706-2 may include a lighting element, e.g., a strip of LEDs, configured to provide illumination in a downward direction 708, i.e., downlighting. The lighting characteristics of the light may be managed by the integrated functional features 706-1, 706-2.

FIG. 8 is a sketch 800 illustrating an isometric view of another example building material structure, illustrating cove lighting for wall washing illumination, and a ceiling portion. Example building material structure 800 includes a wall portion 802-1, and a ceiling portion 802-2. Each portion 802-1, 802-2 includes a respective 3D-printed architectural element 804-1, 804-2. In some embodiments, the wall portion 802-1 is coupled to the ceiling portion 802-2.

The wall portion 802-1 includes a plurality of integrated functional features 806-1, 806-2. The wall portion 802-1 defines a first functional feature 806-1 corresponding to a channel, e.g., a cove, positioned at or near a top surface of the architectural element 804-1. A cross-section of the channel is illustrated as semi-circular. However, this disclosure is not limited in this regard. The cross-section of the channel 806-1 may be rectangular, square, ellipsoidal, uniform, nonuniform and/or freeform. The first functional feature 806-1 is configured to receive a second functional feature 806-2. The second functional feature 806-2 may include a lighting element, e.g., a strip of LEDs, configured to provide illumination in an upward direction 808, i.e., uplighting. The illumination may reflect from a bottom surface 810 of the ceiling portion 802-2. Thus, the first functional feature 806-1 is configured to accommodate the second functional feature, i.e., functional element 806-2.

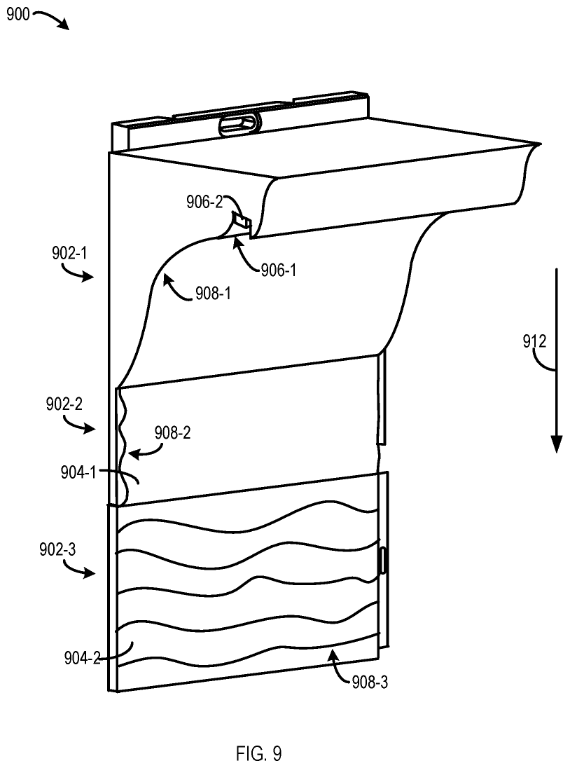

FIG. 9 is a sketch 900 illustrating an isometric view of an example building material system portion, illustrating one example of a plurality of interconnected building material elements 902-1, 902-2, 902-3. One or more of the building material elements 902-1, 902-2, and/or 902-3 may each include one or more respective functional feature(s) and/or one or more respective decorative features. In this example 900, a first building material element 902-1 includes plurality of functional features 906-1, 906-2, and each building material element 902-1, 902-2, 902-3 includes a respective decorative feature 908-1, 908-2, 908-3. Example 900 is configured to illustrate one example of crown molding (i.e., trim), e.g., decorative feature 908-1, cove lighting 906-1, 906-2, and a plurality of interconnected building material elements 902-1, 902-2, 902-3.

A first building material element 902-1 corresponds to at least a portion of a crown molding and defines a cove 906-1 configured to receive a light engine 906-2, e.g., an LED strip, as described herein. The first building material element 902-1 includes a curved decorative feature 908-1. A second building material element 902-2 may be interconnected with the first building material element 902-1 and includes surface decorative features 908-2 on a front surface 904-1. A third building material element 902-3, may be interconnected with the second building material element 902-2 and includes surface decorative features 908-3 on a front surface 904-2. The second functional feature 906-2 may include a lighting element, e.g., a strip of LEDs, configured to provide illumination in a downward direction 912, i.e., downlighting.

It may be appreciated that additional building material system portions corresponding to building material system portion 900 may be interconnected to building material system portion 900 (and each other) to extend a size of a corresponding building material system. Additionally or alternatively, additional building material elements may be included to further extend the size. Such extensibility may facilitate forming a building material system of a target size that includes integrated functional features and decorative features.

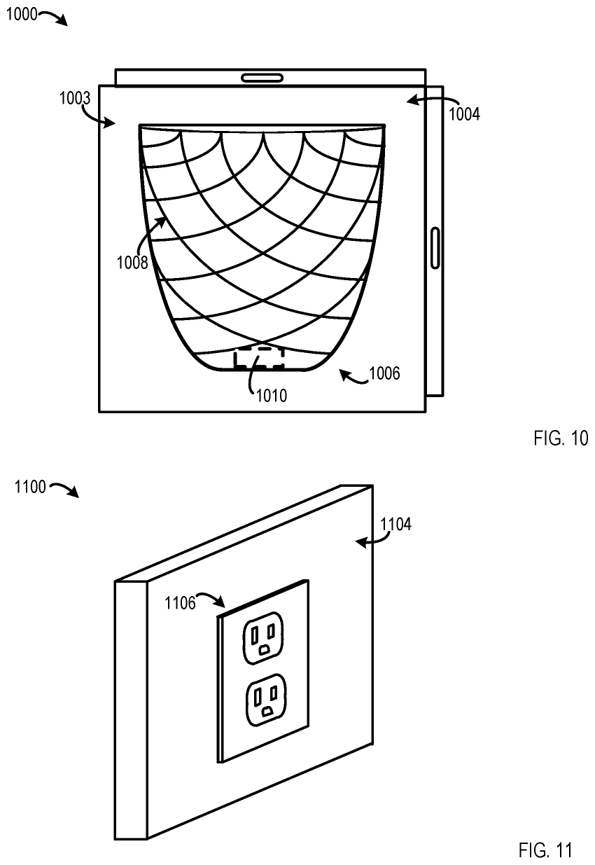

FIG. 10 is a sketch 1000 illustrating a front view of an example building material element, according to an embodiment of the present disclosure. Building material element 1000 includes a 3D-printed architectural element 1004 and an integrated functional feature 1006. In an embodiment, the integrated functional feature 1006 may correspond to a sconce. The sconce may be configured to protrude from a front surface 1003 of 3D-printed architectural element 1004. In this embodiment, a light source 1010 may be positioned between the front surface 1003 of the 3D-printed architectural element 1004 and the sconce 1006. In one nonlimiting example, the light source 1010 may correspond to an array of LEDs.

The sconce 1006 may include surface decorative features 1008, that may include varying a surface texture of the sconce 1006. A thickness of a wall of the sconce 1006 may be varied, configured to achieve decorative aspects, that may be enhanced by the light source 1010. The sconce 1006, corresponding to an integrated functional feature configured to accommodate a functional element (i.e., light source 1010), may be configured to transfer light energy received from the light source 1010 out of the building material element 1000. The sconce 1006 may be transparent and/or translucent, and may thus be decorative. In one nonlimiting example, the sconce may be translucent, with an amount of translucence varying over a surface of the sconce 1006.

In another embodiment, the integrated functional feature 1006 may be configured to accommodate a light source positioned behind the front surface 1003 of the 3D-printed architectural element 1004. In this embodiment, the surface decorative features 1008 may be achieved by varying a translucence (e.g., varying a thickness) of the 3D-printed architectural element 1004. The front surface 1003 may then be generally flat, i.e., within a plane of the front surface 1003. In operation, surface decorative features 1008 may then be visible when the light source(s) are turned on, and generally not visible when the light source(s) are turned off.

It may be appreciated that 3D printing may provide a relatively wide range of options for surface texture and decorative features. The decorative features may be three-dimensional, and/or may include, but are not limited to, geometric shapes, depictions of flora and/or fauna, and/or may be freeform. In some embodiments, both a 3D-printed architectural element and an integrated functional feature may include decorative features. In some embodiments, one of the 3D-printed architectural element or the integrated functional feature may include decorative feature(s).

FIG. 11 is a sketch 1100 illustrating a front view of an example building material element including a duplex electrical outlet, according to one embodiment of the present disclosure. Building material element 1100 includes a 3D-printed architectural element 1104 and an integrated functional feature 1106. In this example, the functional feature 1106 corresponds to a functional element, e.g., a duplex electrical outlet. Functional elements may include, but are not limited to, other types of outlets (e.g., telephone, Ethernet, cable television, USB, alarm), controllers (e.g. wall switches, dimmer switches, timer), and/or sensor hubs (e.g., light, temperature, relative humidity, smoke, water, carbon monoxide (CO), carbon dioxide (CO₂), etc. It may be appreciated that, 3D printing may provide a relatively wide range of options for functional and/or decorative features.

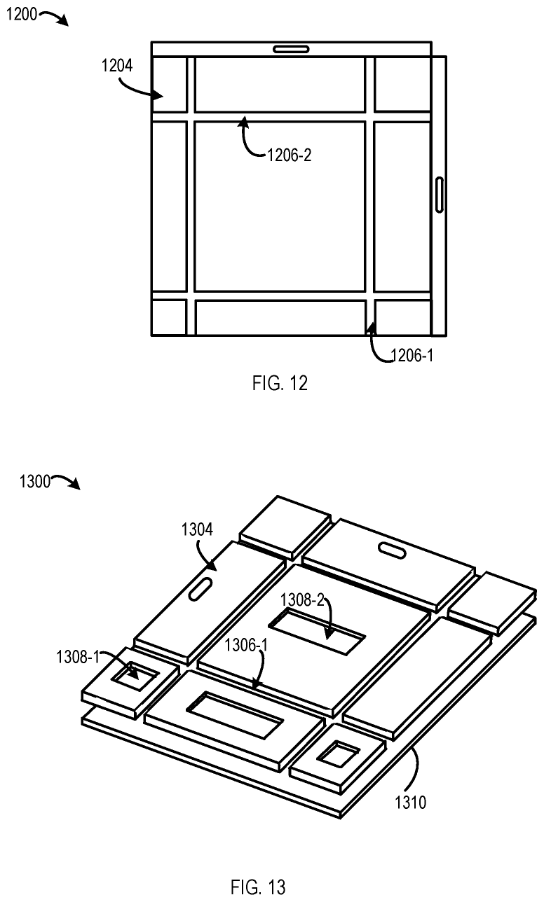

FIG. 12 is a sketch 1200 illustrating a back view of an example building material element, illustrating example structural features, according to an embodiment of the present disclosure. Building material element 1200 includes a back surface 1204 and a plurality of structural features, e.g., structural features 1206-1, 1206-2. The structural features 1206-1, 1206-2 are configured to provide a strength, e.g., rigidity to the building material element 1200. The structural features may have a thickness greater than a thickness of adjacent regions of the building material element 1200.

FIG. 13 is a sketch 1300 of an isometric view of a back side of an example building material element, illustrating functional features configured to accommodate functional element(s), according to an embodiment of the present disclosure. Example 1300 is configured to illustrate integrated functional features that may not be visible in a front view of a building material element. Example building material element has a back surface 1304. The back surface 1304 defines a plurality of channels, e.g., channel 1306-1, configured to accommodate, for example, electrical wiring. Additionally or alternatively, the back surface 1304 may defines a plurality of openings, e.g., openings 1308-1, 1308-2. A first opening 1308-1 may be configured to receive an electrical connectivity apparatus, for example, electrical wiring. The electrical wiring may be configured to power integrated lighting, e.g., LED(s). A second opening 1308-2 may be configured to receive a sensor. One or more sensors may be configured to sense one or more of an environmental parameter, an electrical parameter, an electromagnetic parameter, a mechanical parameter, and/or an acoustic parameter. Thus, each functional feature 1306-1, 1308-1, 1308-2 is configured to accommodate a functional element. It may be appreciated that the 3D printing provides a relatively wide range of options for functional features.

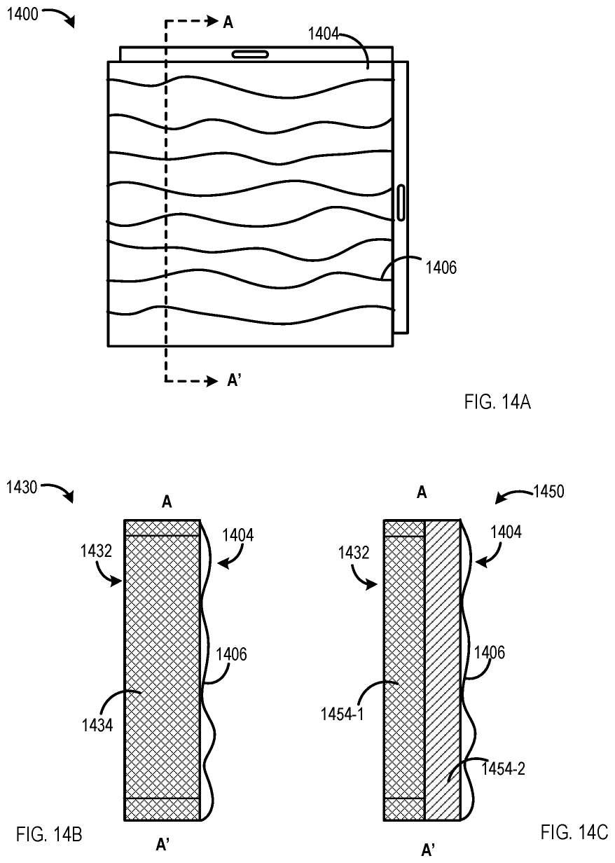

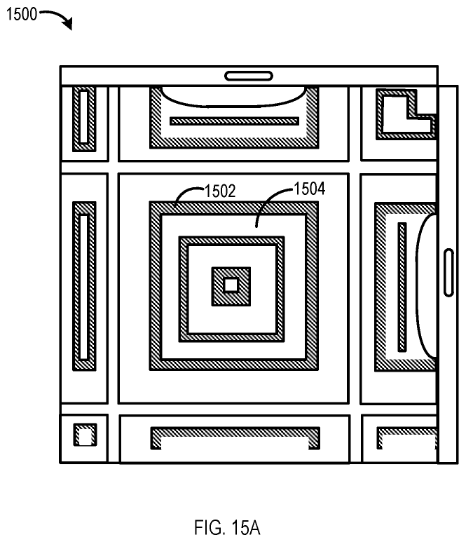

FIGS. 14A through 14C are configured to illustrate a plurality of infill characteristics of the building material element 1400. FIG. 14A is a sketch 1400 of a front view of an example building material element, according to several embodiments of the present disclosure. FIGS. 14B and 14C illustrate cross-sections A-A′ of two embodiments 1430, 1450 of the example building material element 1400 of FIG. 14A, configured to illustrate infill, according to several embodiments of the present disclosure. FIGS. 14B and 14C may be best understood when considered in combination with FIG. 14A. Example building material element 1400 includes a front surface 1404 and may further include a plurality of decorative features, e.g., decorative feature 1406.

An infill characteristic may be configured to provide a target physical characteristic for a building material element, and associated building material system. Infill characteristics may include, but are not limited to, an infill percentage, an infill pattern, and/or a selected infill material. Each infill material may be selected from a 3D printing material, as described herein, and may be selected based, at least in part, on a material characteristic. An infill characteristic may be selected based, at least in part, on a target physical characteristic of the corresponding building material element. Target physical characteristics include, but are not limited to, a thermal characteristic, a mechanical characteristic, a weight, etc. In one nonlimiting example, a thermal characteristic may correspond to a thermal conductivity. In another example, a target physical characteristic may correspond to a liquid (or gas) permeability of the building material element.

Turning now to FIG. 14B, a first cross-section A-A′ 1430 may include the front surface 1404 and a cross-section of decorative feature 1406. The first cross-section 1430 includes a back surface 1432 and an internal region 1434 bounded by, the front surface 1404 and the back surface 1432. The internal region 1434 may contain an infill material and/or may contain an internal structure that defines a plurality of voids in the internal region 1434. An amount of infill material may be quantified as a percentage of infill material present in the internal region 1434. The internal structure of the infill material may correspond to an infill pattern.

Turning now to FIG. 14C, a second cross-section A-A′ 1450 may include the front surface 1404 and the cross-section of decorative feature 1406. The second cross-section 1430 includes the back surface 1432 and a plurality of internal regions 1454-1, 1454-2, bounded by the front surface 1404 and the back surface 1432. A first internal region 1454-1 is positioned adjacent the back surface 1432, between the back surface 1432 and a second internal region 1454-2. The second internal region 1454-2 is positioned adjacent the first internal region 1454-1, between the first internal region 1454-1 and the front surface 1404. The first internal region 1454-1 may contain an infill material and/or may contain an internal structure that defines a plurality of voids in the internal region. An amount of infill material may be quantified as a percentage of infill material present in the first internal region 1454-1. The internal structure may correspond to an infill pattern. In this example 1450, the second internal region 1454-2 may generally correspond to a solid structure.

Thus, a building material element, according to the present disclosure, may be configured with a selected infill characteristic. The selected infill characteristic(s) may be configured to achieve a target physical characteristic.

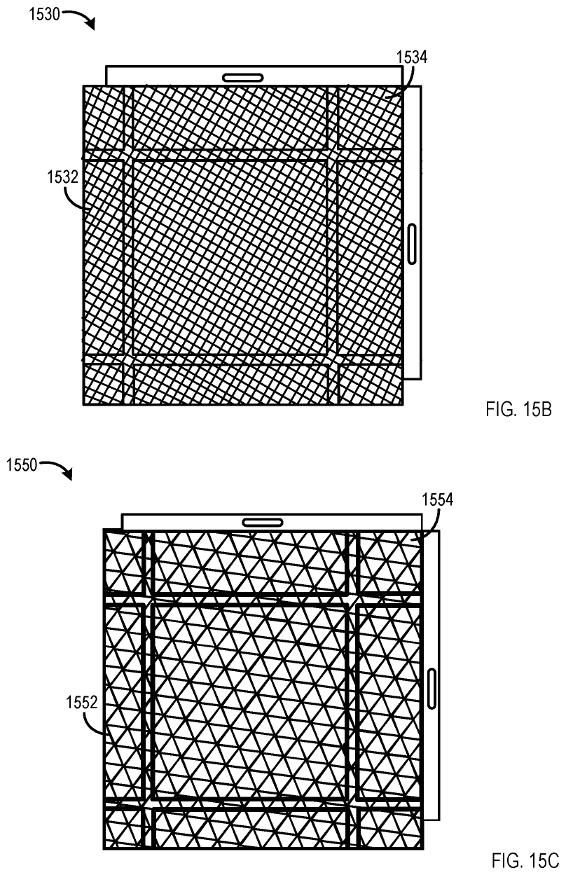

FIGS. 15A through 15C are sketches 1500, 1530, 1550 of internal structures of example building material elements configured to illustrate a plurality of example infill characteristics of the building material element 1400 of FIG. 14A. FIGS. 15A through 15C may be best understood when considered in combination with FIG. 14A. Infill characteristics may include, but are not limited to, an infill percentage, an infill pattern, and an infill material, as described herein. An infill characteristic may be selected based, at least in part, on a target physical characteristic of the corresponding building material element, as described herein.

Turning now to FIG. 15A, sketch 1500 is one example of a concentric infill structure. Sketch 1500 includes a plurality of concentric infill regions, e.g., infill region 1502, and a plurality of voids, e.g., void 1504, defined, at least partially, by the infill regions. In one nonlimiting example, an amount of infill material may be quantified as a percentage (e.g., 10%, 20%, 40%, etc.) corresponding to a fraction of the building material element volume that is infill material. However, this disclosure is not limited in this regard.

Turning now to FIG. 15B, sketch 1530 is one example of a grid infill structure. Sketch 1530 includes a plurality of infill regions, e.g., infill region 1532, arranged in a grid structure. Building material element 1530 further includes a plurality of voids, e.g., void 1534, defined, at least partially, by the infill regions. It may be appreciated that a relatively higher percentage infill may correspond to a relatively finer grid and a relatively lower percentage infill may correspond to a relatively coarser grid.

Turning now to FIG. 15C, sketch 1550 is one example of a triangular infill structure. Sketch 1550 includes a plurality of infill regions, e.g., infill region 1552, arranged in a triangular structure. Building material element 1550 further includes a plurality of voids, e.g., void 1554, defined, at least partially, by the infill regions. It may be appreciated that a relatively higher percentage infill may correspond to a relatively finer infill structure and a relatively lower percentage infill may correspond to a relatively coarser structure.

Thus, a building material element, according to the present disclosure, may be configured with a selected infill characteristic, as described herein. The selected infill characteristic(s) may be configured to achieve a target physical characteristic, as described herein.

Generally, there is disclosed herein a building material system that includes at least one building material element. In some embodiments, the building material element may be modular such that a plurality of building material elements may be interconnected to form a corresponding building material system. The building material element includes a 3D-printed architectural element and may include an integrated functional feature related to a functional element. In some embodiments, a 3D-printed architectural element may include a decorative feature.

Flexibility associated with 3D printing may facilitate producing a building material system of nearly any size, with a customized surface texture, and that includes one or more selected integrated functional features (e.g., integrated lighting).

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A building material element comprising:
a three-dimensional (3D)-printed architectural element; and
an integrated functional feature related to a functional element.

2. The building material element of claim 1, wherein the 3D-printed architectural element is selected from the group comprising at least a portion of a wall panel, at least a portion of a ceiling panel, at least a portion of a floor panel, at least a portion of a crown molding, at least a portion of a chair railing, and at least a portion of a floor molding.

3. The building material element of claim 1, wherein the 3D-printed architectural element comprises a decorative feature.

4. The building material element according to claim 1, wherein the integrated functional feature is configured to accommodate the functional element.

5. The building material element according to claim 1, wherein the integrated functional feature corresponds to the functional element.

6. The building material element of claim 4, wherein the functional element comprises one or more of a lighting apparatus, an electrical connectivity apparatus, an electronic device, a computing device, a communication device, a sensor hub, and/or a sensor.

7. The building material element of claim 5, wherein the functional element comprises a 3D-printed insulation material.

8. The building material element of claim 6, wherein the sensor is configured to sense one or more of an environmental parameter, an electrical parameter, an electromagnetic parameter, a mechanical parameter, and/or an acoustic parameter.

9. The building material element of claim 7, wherein an infill characteristic of the 3D-printed insulation material is selected based, at least in part, on a target physical characteristic, the target physical characteristic selected from the group comprising a target thermal characteristic, a target mechanical characteristic, a target weight of the building material element, and/or a target permeability, the infill characteristic selected from the group comprising an infill pattern, an infill percentage, and a selected infill material.

10. A building material system comprising:
a plurality of interconnected building material elements, each building material element comprising a three-dimensional (3D)-printed architectural element, and an integrated functional feature related to a functional element; and
a light source associated with a selected building material element.

11. The building material system of claim 10, wherein each 3D-printed architectural element is the same as each other 3D-printed architectural element.

12. The building material system of claim 10, wherein at least one 3D-printed architectural element is a different type from at least one other 3D-printed architectural element.

13. The building material system of claim 10, wherein each 3D-printed architectural element is selected from the group comprising at least a portion of a wall panel, at least a portion of a ceiling panel, at least a portion of a floor panel, at least a portion of a crown molding, at least a portion of a chair railing, and at least a portion of a floor molding.

14. The building material system of claim 10, wherein at least one 3D-printed architectural element comprises a decorative feature.

15. The building material system according to claim 10, wherein at least one integrated functional feature is configured to accommodate the functional element.

16. The building material system according to claim 10, wherein at least one integrated functional feature corresponds to the functional element.

17. The building material system of claim 15, wherein the functional element comprises one or more of a lighting apparatus, an electrical connectivity apparatus, an electronic device, a computing device, a communication device, a sensor hub, and/or a sensor.

18. The building material system of claim 16, wherein the functional element comprises a 3D-printed insulation material.

19. The building material system of claim 17, wherein the sensor is configured to sense one or more of an environmental parameter, an electrical parameter, an electromagnetic parameter, a mechanical parameter, and/or an acoustic parameter.

20. The building material system of claim 18, wherein an infill characteristic of the 3D-printed insulation material is selected based, at least in part, on a target physical characteristic, the target physical characteristic selected from the group comprising a target thermal characteristic, a target mechanical characteristic, a target weight of the building material element, and/or a target permeability, the infill characteristic selected from the group comprising an infill pattern, an infill percentage, and a selected infill material.
